(19) United States
(12) Patent Application Publication
(10) Pub. No.: US 2015/0065613 A1
(43) Pub. Date: Mar. 5, 2015

(54) EPOXY ADHESIVE COMPOSITION

(71) Applicants: Dow Global Technologies LLC, Midland, MI (US); Dow MF Produktions GmbH & Co. OHG, Rheinmuenster (DE)

(72) Inventors: Bharati Balijepalli, Midland, MI (US); Theofanis Theofanous, Lake Jackson, TX (US); Bernd Hoevel, Sinzheim (DE); Nikhil E. Verghese, Lake Jackson, TX (US); Ha Q. Pham, Lake Jackson, TX (US)

(73) Assignees: Dow MF Produktions GmbH & Co. OHG, Rheinmuenster (DE); The Dow Chemical Company, Midland, MI (US)

(21) Appl. No.: 14/387,555

(22) PCT Filed: Apr. 3, 2013
(86) PCT No.: PCT/US2013/035106

§ 371 Date: Sep. 24, 2014

Related U.S. Application Data
(60) Provisional application No. 61/638,713, filed on Apr. 26, 2012.

(51) Int. Cl. C09J 163/00; C08K 7/14; C08K 3/36

(52) U.S. Cl. CPC C09J 163/00; C08K 3/36; C08K 7/14; C09J 2463/00
USPC 523/466

(57) ABSTRACT

A curable epoxy adhesive composition including (a) at least one first epoxy resin; (b) at least one first diluent; (c) at least one first hardener; (d) at least a first hydrophilic filler that has a predetermined aspect ratio; (e) at least a second hydrophobic filler that is different from the first filler and that has a predetermined aspect ratio; and (f) at least a third filler that is different from the first and second fillers; wherein the third filler has a predetermined aspect ratio higher than the first filler and the second filer; and wherein the volume ratio of the third filler to the combination of the first filler and second filler is in the range of from 1:1 to 10:1 such as to minimize the thermal residual stresses of the cured product made from the curable composition.

### FIELD

The present invention is related to an epoxy resin adhesive composition. More specifically, the present invention is related to a rheology-controlled epoxy adhesive composition having low residual stress.

### BACKGROUND

It is known that sag-resistance is an important and highly desired property in adhesive compositions particularly those adhesive compositions which are used in applications in which the adhesive is to be applied to vertical surfaces. Many two-component epoxy adhesives having non-sagging behavior are known in the prior art and are commercially available.

The sag resistance in prior art adhesive compositions typically is achieved by using known thixotropic fillers in the adhesive components. Such thixotropic fillers include fumed silica and other similar materials. Although use of fumed silica for improved thixotropy does provide non-sagging character to the adhesive composition, the presence of fumed silica in appreciable amounts in the adhesive composition also increases the viscosity of the components. Highly viscous components can make mixing difficult; poor mixing can lead to reduced properties of the cured article. Additional processing drawbacks can include difficulty in transferring and/or pumping the two components as well as dispensing and application of the adhesive composition. The high viscosities of current adhesives are also known to result in air entrapments which could act as defect points leading to joint failure in structural articles.

A rheology controlled adhesive refers to an adhesive that consists of individual components which have a suitable viscosity that enable the components to flow under gravity, but which upon mixing rapidly develop a sag resistant character, so that the resultant mixture will not sag, drip, or migrate after application to a surface during the open time before the joining of parts. WO2005/042630A2; U.S. Pat. No. 5,775,728; and U.S. Pat. No. 4,578,424 describe various methods to achieve rheology control of a formulation. However, the cured product made from the compositions disclosed in the above known references suffer from excessive (greater than 5 MPa) residual stress.

Two-component epoxy systems based on an epoxy resin-amine hardener mixture are known to give brittle polymers. Such adhesives can be highly susceptible to stress cracking when subjected to cycling temperatures during the article manufacturing process. This stress cracking problem occurs because of the buildup of residual stresses in the bond line due to the dissimilar thermal expansion coefficients of the adhesive and the substrate materials. The usual inclusion of tougheners to lower residual stresses in the bond line results in the loss of mobility of the individual epoxy resin and amine hardener components prior to mixing, thus not permitting the gravity feed option. Existing compositions do not possess the desired balance between flowability properties; and sag, drip, and migration resistant properties, with low (below 5 MPa) residual stress requirements.

### SUMMARY

The problems of the prior art are addressed by the present invention. The present invention is directed to a novel curable epoxy adhesive composition with low residual stresses making the adhesive composition more stable to thermal cycling, without compromising the processability of the composition.

In one embodiment, the curable epoxy adhesive composition includes (a) at least one first epoxy resin; (b) at least one first diluent; (c) at least one first hardener; (d) at least a first hydrophilic filler that has a predetermined aspect ratio; (e) at least a second hydrophobic filler that is different from the first filler, and that has a predetermined aspect ratio; and (f) at least a third filler that is different from the first and second fillers; wherein the third filler has a predetermined aspect ratio higher than the first filler and the second filler; and wherein the volume ratio of the third filler to the combination of the first filler and second filler is in the range of from 1:1 to 10:1 such as to minimize the thermal residual stresses of the cured composition.

The adhesive composition comprises a resin and a hardener with low viscosities (no greater than 30 Pascal-seconds under an applied shear rate of 10 reciprocal seconds at 25 degrees Celsius [° C.]) which, when mixed together, yields a sag-resistant paste. The balance of low residual stress and rheology control can be achieved by an appropriate combination of epoxy resins, curing agents, filler type and filler loading.

In one embodiment, the present invention includes a two-component epoxy structural adhesive formulation, wherein the formulation includes a rheology-controlled epoxy adhesive formulation with low residual stress.

One preferred embodiment of the present invention is directed to a rheology-controlled epoxy adhesive composition including (a) an epoxy resin including (i) at least a first epoxy resin and (ii) at least a second epoxy resin; and (b) a hardener including (i) at least a first hardener and (ii) at least a second hardener.

Another embodiment of the present invention includes a process for preparing the above epoxy adhesive composition.

Still another embodiment of the present invention includes a cured thermoset resulting from curing the above epoxy adhesive composition.

Some of the unique advantages/properties of the epoxy adhesive composition of the present invention include for example the following: individual components with low viscosities enabling them to be used by gravity feed methods; non-sagging character of the mixed adhesive before gelation; and reasonably long room temperature (application temperature) open time (usually 45 minutes).

Some of the advantages of the cured thermoset include for example improved toughness and resistance to stress cracking in the final adhesive bond, and a high adhesive performance with many types of substrate materials.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a graphical illustration showing the rheological behavior of epoxy adhesive compositions of the present invention under shear rates ranging from 0 to 1000 seconds⁻¹.

### DETAILED DESCRIPTION

In its broadest scope, the present invention is directed to a curable epoxy adhesive composition comprising: (a) at least one first epoxy; (b) at least one first diluent; (c) at least one first hardener; (d) at least a first hydrophilic filler that has a predetermined aspect ratio and that advantageously determines the rheology of the curable composition; (e) at least a second hydrophobic filler that has a predetermined aspect ratio and that is different from the first filler; and (f) at least a third filler that is different from the first and second fillers, and that has a predetermined higher aspect ratio than the first and second fillers; and wherein the volume ratio of the third filler to the combination of the first filler and second filler is in the range of from 1:1 to 10:1 such as to minimize the thermal residual stresses of the cured product being cured from the curable composition.

Another broadest scope of the present invention is directed to a curable epoxy adhesive composition including at least a two-component system wherein one component includes (I) an epoxy resin composition, and wherein the other component includes (II) a hardener composition. In addition, any one or both of the two components (I) and (II) described above includes at least two different fillers having predetermined aspect ratios. In a preferred embodiment, various amounts of the two different fillers are added to component (I) and component (II).

“Rheology control” herein means individual components have suitable viscosity that enable them to flow under gravity, but which upon mixing rapidly develop a sag resistant character, so that the mixture will not sag, drip, or migrate after application to a surface during the open time before the joining of parts.

“Sag resistant” herein means resistance to flow of a bead of adhesive when placed on a vertical plane.

“Crack resistant” herein means ability of a material to resist formation and propagation of cracks.

“Residual stresses” herein means stresses that remain in material or body without application of an external load.

“Structural adhesives” herein means strong adhesives used to bond load bearing structures and are capable of transferring required loads between adherents.

The curable epoxy adhesive composition or formulation of the present invention includes at least a first epoxy compound; and the first epoxy compound may include one epoxy or may include a combination of two or more epoxy compounds. The epoxy compounds useful in the present invention are those compounds containing at least one vicinal epoxy group and may include a wide variety of epoxy compounds. For example, the epoxy compound may be saturated or unsaturated, aliphatic, cycloaliphatic, aromatic or heterocyclic and may be substituted. The epoxy compound may be monomeric or polymeric.

For example, the curable composition of the present invention may include, one or more epoxy compounds known in the art such as epoxy compounds described in Pham, H. Q. and Marks, M. J., Epoxy Resins, the Kirk-Othmer Encyclopedia of Chemical Technology; John Wiley & Sons, Inc.: online Dec. 4, 2004 and in the references therein; in Lee, H. and Neville, K., Handbook of Epoxy Resins, McGraw-Hill Book Company, New York, 1967, Chapter 2, pages 2-1 to 2-33, and in the references therein; May, C. A. Ed., Epoxy Resins: Chemistry and Technology, Marcel Dekker Inc., New York, 1988 and in the references therein; and in U.S. Pat. No. 3,117,099; all which are incorporated herein by reference.

Some of the epoxy compounds useful in the present invention include for example epoxy compounds based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy compounds known in the art include for example reaction products of epichlorohydrin with o-cresol novolacs, hydrocarbon novolacs, and, phenol novolacs. The epoxy compound may also be selected from commercially available products such as for example, D.E.R. 331®, D.E.R. 332, D.E.R. 354, D.E.R. 580, D.E.N. 425, D.E.N. 431, D.E.N. 438, D.E.R. 736, or D.E.R. 732 epoxy resins available from The Dow Chemical Company.

In general, at least one of the epoxy resins used in the composition of the present invention, has a viscosity of between 1 mPa-s and 100,000 mPa-s in one embodiment, between 5 mPa-s and 50,000 mPa-s in another embodiment, between 10 mPa-s and 10,000 mPa-s in still another embodiment, and between 10 mPa-s and 1,000 mPa-s in yet another embodiment, at ambient temperature (20° C. to 25° C.).

The concentration of the epoxy resin used in the present invention may range generally from 20 weight percent (wt %) to 70 wt % in one embodiment, from 30 wt % to 65 wt % in another embodiment, and from 35 wt % to 60 wt % in still another embodiment, based on the total weight of the composition.

In another embodiment, the composition may have the following stoichiometric ratios of total epoxy resin to total hardener such as for example generally in the range of from 1 to 0.8 (epoxy:hardener) in one embodiment, from 1 to 1.2 in another embodiment, and from 1 to 1 in still another embodiment.

As aforementioned, the curable epoxy adhesive composition of the present invention may include two or more epoxy compounds in combination. If at least a second epoxy compound is used, the second epoxy compound may include at least one epoxy compound selected from any of the epoxy compounds described above with reference to the first epoxy compound. In one preferred embodiment the second epoxy compound may be a diluent as discussed herein below.

Similar to the first epoxy compound, a wide range of epoxy compounds can be used in the curable composition as the second epoxy compound. Some examples of suitable second epoxy compound include other diglycidyl ethers of bisphenol A and bisphenol F such as are sold by The Dow Chemical Company under the designations D.E.R. 330, D.E.R. 332, D.E.R. 383 and D.E.R. 354.

The epoxy adhesive composition of the present invention includes at least a first diluent in an amount sufficient to provide the composition with a viscosity for processing the composition. The first diluent may include one diluent compound or may include a combination of two or more diluent compounds.

A wide range of diluents can be used in the curable epoxy resin composition. For example, the first diluent can be a reactive diluent and participate in a chemical reaction with at least one or more other materials in the curable composition during curing and thus becomes incorporated into the cured epoxy thermoset. Alternatively, the first diluent can be non-reactive. In another embodiment, the first diluent may be an epoxy compound as described herein above.

Advantageously, diluents can be used to vary the cure characteristics, extend pot life, improve adhesion properties of the curable compositions, and adjust the viscosity of curable compositions.

The amount of diluent used in the resin composition generally can be within a range of from 1 wt % to 90 wt % in one embodiment, within a range of from 2 wt % to 50 wt % in another embodiment, and within a range of from 3 wt % to 20 wt % in still another embodiment, based on the total weight of the resin component. For the embodiments disclosed herein, the first diluent may be blended with the epoxy resin component, or the first diluent may be blended with the hardener component when preparing the curable epoxy resin composition.

In a preferred embodiment, the diluent used in the present invention may be a polymeric glycidyl ether. The polymeric glycidyl ether can be formed from units which include polyalkylene oxide reacted with epichlorohydrin to form glycidyl ethers. The glycidyl ether can be selected from the group consisting of allyl glycidyl ethers, diglycidyl ethers, phenyl glycidyl ethers, alkyl glycidyl ethers, and combinations thereof. Sometimes, polymeric glycidyl ethers can be formed by a reaction of mono- to poly-hydroxyl compounds with alkylene oxides and a conversion of the polyether polyol reaction product into a glycidyl ether with epichlorohydrin and subsequent treatment of the former intermediate with aqueous sodium hydroxide. Additionally, cycloaliphatic epoxy resins can be used as the diluent.

Examples of the first diluent include mono- and diglycidyl ethers of aliphatic alcohols and polyether glycols such as C2-C24 alkylene glycols and poly(ethylene oxide) or poly(propylene oxide)glycols, and mixtures thereof. Commercially available diglycidyl ethers of alcohols that are useful include for example 1,6-Hexanediol diglycidylether, 1,4-butanediol diglycidylether, and mixtures thereof.

The present invention may also use polyglycidyl ethers that may be derived from aliphatic polyalcohols, such as ethylene glycol, diethylene glycol, triethylene glycol, 1,2-propylene glycol, 1,4-butylene glycol, triethylene glycol, 1,5-pentanediol, 1,6-hexanediol, cyclohexane dimethanol, trimethylolpropane, or mixtures thereof.

The present invention may also use known non-reactive diluents or plasticizers such as for example benzyl alcohol, nonyl phenol, furfuryl alcohol, dibutylphthalate, dioctylphthalate, pine oil, castor oil, soybean oil, or mixtures thereof.

As aforementioned, the curable epoxy adhesive composition of the present invention may include two or more diluents in combination. If at least a second diluent compound is used, the second diluent may includes a diluent selected from any of the diluents described above with regard to the first diluent and can be different from the first diluent. The second diluent may also be an epoxy resin or a non-epoxy resin.

The curable epoxy adhesive composition of the present invention includes at least a first hardener compound; and the first hardener may include one hardener or may include a combination of two or more hardener compounds. The first hardener compound of the curable resin composition useful in the present invention may be selected from any known hardeners in the art. The first hardener compound may be blended with epoxy resins described above.

For example, the first hardener (also referred to as a curing agent or cross-linking agent) useful in the present invention may be any compound having an active group being reactive with the reactive epoxy group of the epoxy resin. The chemistry of such curing agents is described in the previously referenced books on epoxy resins. The curing agent useful in the present invention includes nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, phenolic-terminated epoxy resins; sulfur-containing compounds such as polysulfides, polymercaptans; and catalytic curing agents such tertiary amines, Lewis acids, Lewis bases and combinations of two or more of the above curing agents.

Practically, polyamines, dicyandiamide, diaminodiphenylsulfone and their isomers, aminobenzoates, various acid anhydrides, phenol-novolac resins and cresol-novolac resins, for example, may be used in the present invention, but the present invention is not restricted to the use of these compounds.

The hardeners of choice may depend on the application requirements. Generally, the hardener useful in the present invention may be selected from, for example, but are not limited to, dicyandiamide, substituted guanidines, phenolic, amino, benzoxazine, anhydrides, amido amines, polyamides, polyamines, aromatic amines, polyoxypropylene diamines, carbodiimides, polyesters, polyisocyanates, polymercaptans, urea formaldehyde and melamine formaldehyde resins, and mixtures thereof.

In one embodiment, the at least one first hardener may include one or more of aliphatic amines such as ethanolamine, ethylenediamine, DETA, triethyleneaminetetramine (TETA), isophorone diamine (IPDA), 1-(o-tolyl)-biguanide, dicyandiamide, amine-terminated polyols, aromatic amines such as methylenedianiline (MDA), toluenediamine (TDA), diethyltoluenediamine (DETDA), Versamid (trademark of Cognis) hardeners, Genamid (trademark of Cognis) hardeners, Jeffamine (trademark of Huntsman) hardeners, diaminodiphenylsulfone (DADS), polyphenols such as bisphenol A, bisphenol F, 1,1-bis(4-hydroxyphenyl)-ethane, hydroquinone, resorcinol, catechol, tetrabromobisphenol A, novolacs such as phenol novolac, bisphenol A novolac, hydroquinone novolac, resorcinol novolac, naphthol novolac, mercaptans such as mercaptan-terminated polysulfide polymers, Capcure (trademark of Cognis) hardeners, anhydrides such as phthalic anhydride, trimellitic anhydride, nadic methyl anhydride, methyl tetrahydrophthalic anhydride, methyl hexahydrophthalic anhydride; and mixtures thereof.

For the above embodiments, the hardener is used generally within a range of from 5 wt % to 50 wt % in one embodiment, within a range of from 10 wt % to 35 wt % in another embodiment, and within a range of 15 wt % to 30 wt % in still another embodiment, based on the total weight of the composition.

As aforementioned, the curable epoxy adhesive composition of the present invention may include two or more hardeners in combination. If at least a second hardener compound is used, the second hardener may include a hardener selected from any of the hardeners described above with regard to the first hardener; and the at least second hardener compound includes at least one different hardener of any of the hardeners described above with regard to the first hardener.

For example, the first hardener and second hardener may include one or more different amine curing agents. In one preferred embodiment, the first and second hardeners include a combination of polyamidoamine, isophorone diamine, and polyoxypropylenediamine.

The curable epoxy adhesive composition of the present invention includes at least a first filler material. The first filler material is used to improve the viscosity of the curable composition and the properties of the resulting cured product made from the curable composition. A cured thermoset with various improved properties are useful in various applications.

The first filler useful in the present invention may include one filler or may include a combination of two or more filler compounds. The at least a first filler advantageously has a predetermined size and predetermined aspect ratio; and is used to determine or affect the rheology of the curable composition. In one embodiment, the first filler may include for example one or more types of thixotropic agents or rheology control agents. In one preferred embodiment of the present invention, the curable composition contains at least one fumed silica. Fumed silica thixotropic agents used in the present invention may be selected from fumed silica known in the art; or may be selected from commercially available fumed silica from several commercial sources, including the fumed silica products sold under the CAB-O-SIL trademark by Cabot Corporation, fumed silica products sold under the HDK trademark by Wacker, and the fumed silica products sold under the AEROSIL trademark by Degussa. Both hydrophilic and hydrophobic fumed silicas are useful in the present invention. Hydrophobic fumed silica is fumed silica that has been reacted with a compound (usually an organosilicon compound such as dimethyldichlorosilane, trimethoxyoctylsilane, polydimethylsiloxane or hexamethyldisilazane) to replace at least a portion of the hydroxyl groups on the surface of the fumed silica with other groups such as methyl groups. In one embodiment of the present invention, the fumed silica has a BET surface area in the range of from 80 m²/g to 300 m²/g; and/or a carbon content of from 0.5 wt % to 7 wt %. Methods of preparing hydrophobic fumed silicas are well-known in the art and include, for example, the methods described in U.S. Pat. Nos. 2,739,075 and 2,786,042, incorporated herein by reference.

Other fillers that can be used as the first filler in the present invention composition include for example thixotropes such as talc, asbestos, colloidal silica, modified bentonite, hydrated magnesium aluminum silicates, nanoclays, or other organic or inorganic particulate filler, or mixtures thereof. The first filler may be either added into the curable composition in its end state or the first filler may be formed in the curable composition in-situ. The first fillers can also be optionally treated to improve filler and polymer interaction.

The acceptable particle size of the first filler material generally may range from nano to conventional micro size. For example, the particle size of the first filler may be generally in the range of from 1 nanometer (nm) to 50 microns (μm) in one embodiment, and from 5 nm to 10 μm in another embodiment.

The acceptable filler morphologies of the first filler material useful in the present invention include platelet, spherical, amorphous or any combination thereof.

Filler loadings of the first filler useful in the present invention may vary. Generally, the concentration of the first filler used in the curable composition may include from 1 wt % to 40 wt % in one embodiment; from 1 wt % to 10 wt % in another embodiment, from 2 wt % to 8 wt % in still another embodiment; and from 4 wt % to 8 wt % in yet another embodiment; based on the total weight of the composition.

The curable epoxy adhesive composition of the present invention includes at least a second filler that is different from the first filler. The second filler material can be used to assist in improving the viscosity of the curable composition and the properties of the resulting cured product made from the curable composition. For example, the second filler similar to the first filler may be used to further determine or affect the rheology of the curable composition.

The second filler useful in the present invention may include one filler or may include a combination of two or more filler compounds. The at least second filler advantageously has a predetermined size and predetermined aspect ratio. In one embodiment, the second filler includes for example one or more types of thixotropic agents or rheology control agents as described above with reference to the first filler. In one preferred embodiment of the present invention, the second filler is at least one hydrophobic fumed silica.

Filler loadings of the second filler useful in the present invention may vary. Generally, the concentration of the second filler used in the curable composition may include from 1 wt % to 40 wt % in one embodiment; from 1 wt % to 10 wt % in another embodiment, from 1 wt % to 5 wt % instill another embodiment; and from 1 wt % to 3 wt % in yet another embodiment; based on the total weight of the composition.

The curable epoxy adhesive composition of the present invention includes at least a third filler that is different from the first and second fillers. The third filler has a different predetermined size and a different predetermined aspect ratio than the first and second fillers. The third filler is advantageously used to determine or affect the stress release of the cured thermoset being cured from the curable composition.

The curable epoxy adhesive composition of the present invention includes a third filler material that is advantageously used to reduce the thermal expansion coefficient of the adhesive and to improve the mechanical strength such as the brittleness and toughness of the cured thermoset resulting from the curable composition.

The third filler material useful in the curable composition may include for example functional or non-functional fillers such as for example, silica, alumina, aluminum trihydroxide, aluminum hydroxide oxide, boron nitride, silicon carbide, mica, aluminum powder, zinc oxide, silver, graphite, aluminum nitride, aluminum oxide, mullite, gold, carbon, carbon nanotubes, graphene, glass fibers/sheets/beads, carbon fibers, or other organic or inorganic particulate filler, or mixtures thereof. The third filler may be either added into the curable composition in its end state or the third filler may be formed in the curable composition in-situ. The third fillers can also be optionally treated to improve filler and polymer interaction.

The third filler material has a higher aspect ratio than the first and second filler materials wherein the length over diameter ratio (l/d) of the third filler is in the range of from 2 to 100. The acceptable filler morphologies of the third filler material useful in the present invention include rod-shaped, fibrous or any combination thereof.

Filler loadings of the third filler useful in the present invention may vary. Generally, the concentration of the third filler used in the composition may include from 1 wt % to 40 wt % in one embodiment, from 10 wt % to 25 wt % in another embodiment, and from 8 wt % to 20 wt % in still another embodiment, based on the total weight of the composition.

The third fillers with different sizes and different shapes may be combined with the first and second filler materials to have a synergistic effect on coefficient of thermal expansion (CTE), modulus, and heat conductivity.

In another embodiment, the curable composition of the present invention can include a combined weight of the first, second and third fillers in the range of from 5 weight percent to 50 weight percent, based on the total weight of the composition.

Optionally, a catalyst can be added to the curable composition to speed up the rate of cure. The curable resin composition of the present invention may include at least one catalyst to facilitate the reaction of the epoxy resin compound with the curing agent. The catalyst useful as an optional component in the composition of the present invention may include catalysts known in the art, such as for example, catalyst compounds containing amine, phosphine, heterocyclic nitrogen, ammonium, phosphonium, arsonium, sulfonium moieties, and any combination thereof. Some non-limiting examples of the catalyst of the present invention may include, for example, ethyltriphenylphosphonium; benzyltrimethylammonium chloride; heterocyclic nitrogen-containing catalysts described in U.S. Pat. No. 4,925,901, incorporated herein by reference; imidazoles; triethylamine; and any combination thereof.

The selection of the optional catalyst useful in the present invention is not limited to any particular catalyst; and commonly used catalysts for epoxy systems can be used. Also, the addition of a catalyst to the composition of the present invention may depend on the system prepared. For example, the catalyst may include tertiary amines, imidazoles, organo-phosphines, acid salts, and mixtures thereof.

In one embodiment, the catalyst may include tertiary amines such as, for example, triethylamine, tripropylamine, tributylamine, 2-methylimidazole, benzyldimethylamine, mixtures thereof.

In another embodiment, the curing catalyst may include for example imidazole derivatives such as 2-ethyl-4-methyl imidazole; tertiary amines; organic metallic salts; and cationic photoinitiators, for example, diaryliodonium salts such as Irgacure™ 250 available from Ciba-Geigy or triarylsulfonium salts such as Cyracure*6992 available from The Dow Chemical Company.

The curing catalyst may be added to the epoxy resin composition component or alternatively, the curing catalyst may be blended into the curable composition.

The concentration of the curing catalyst used in the present invention may be less than 5 wt %; and generally from 0 wt % to 5 wt % in one embodiment, and from 0.01 wt % to 3 wt % in another embodiment, based on the total weight of the curable composition. Lower concentrations of catalyst typically do not provide sufficient catalytic effect, resulting in too slow reactivity of the formulations. Higher concentrations of catalyst typically result in too high reactivity of the formulations.

Other optional components may be used in the present invention including compounds normally used in resin formulations known to those skilled in the art. For example, the optional components may comprise compounds that can be added to the composition to enhance the reaction rate, the selectivity of the reaction, and/or the catalyst lifetime.

An assortment of optional additives may be added to the reactive curable epoxy resin composition of the present invention including for example, other resins, stabilizers, plasticizers, catalyst de-activators, dyes, pigments, thixotropic agents, photo initiators, latent catalysts, inhibitors, solvents, surfactants, fluidity control agents, diluents that aid processing, adhesion promoters, flexibilizers, toughening agents, fire retardants; and mixtures thereof.

The concentration of the optional additives used in the present invention may range generally from 0 wt % to 5 wt % in one embodiment, and from 1 wt % to 3 wt % in another embodiment, based on the weight of all the components in the composition.

The process for preparing the curable epoxy adhesive composition includes admixing the following compounds:
(1) at least one first epoxy;
(2) at least one first diluent;
(3) at least one first hardener;
(4) at least a first hydrophilic filler that has a predetermined aspect ratio and that advantageously determines the rheology of the curable composition;
(5) at least a second hydrophobic filler that has a predetermined aspect ratio and that is different from the first filler; and
(6) at least a third filler that is different from the first and second fillers, and that has a predetermined higher aspect ratio than the first and second fillers; and wherein the volume ratio of the third filler to the combination of the first filler and second filler is in the range of from 1:1 to 10:1 such as to minimize the thermal residual stresses of the cured product being cured from the curable composition.

In one embodiment for example, the preparation of the curable epoxy adhesive formulation of the present invention is achieved by admixing in a vessel the first epoxy, the first hardener, the first filler, the second filler, the third filler, and any other optional additive as desired; and then allowing the compounds to formulate into a curable epoxy adhesive composition. Any of the above-mentioned optional additives, for example a curing catalyst, may also be added to the composition during the mixing or prior to the mixing to form the composition.

In another embodiment, the curable composition of the present invention can be formed using for example a two-component system such as (I) a resin composition component; and (II) a hardener composition component, wherein the fillers and other additives being added into (i) the first component (I), (ii) the second component (II), or (iii) both the first and second components (I) and (II), respectively.

The epoxy composition (I) and hardener composition (II) can be mixed together by known means to form a curable composition. Mixing can be manual, mechanical or a combination thereof. Mixers can include, but are not limited to, a planetary mixer, dispensing the two components from separate component cartridges into a common conduit having a static mix head, where the components are mixed as they pass through the conduit, and/or other types of mixers.

All the compounds of the epoxy resin composition are typically mixed and dispersed at a temperature enabling the preparation of an effective epoxy resin composition having a viscosity for the desired application. The temperature during the mixing of the compounds may be generally from 20° C. to 80° C. in one embodiment, and from 25° C. to 35° C. in another embodiment. Lower mixing temperatures help to minimize reaction of the resin and hardener components to maximize the pot life of the composition.

For the embodiments disclosed herein, because the viscosity of the epoxy resin composition component (I) and the hardener composition component (II) remain relatively low, the two components (I) and (II) can be thoroughly mixed and quickly dispensed. As discussed herein, the viscosity of the epoxy resin composition component (I) and the hardener composition component (II) do not increase prior to forming the curable composition. For example, generally the epoxy resin composition component can have a viscosity within a range of from 1 Pa·s to 70 Pa·s in one embodiment, within a range of from 5 Pa·s to 50 Pa·s in another embodiment, and within a range of from 10 Pa·s to 30 Pa·s in still another embodiment, at 25° C. and under an applied shear of 10 l/s. In addition, generally the hardener composition component can have a viscosity within a range of from 5 Pa·s to 30 Pa·s at 25° C. and under an applied shear of 10 l/s.

The epoxy resin composition component and hardener composition component are mixed together to form the curable composition. Upon contact, the viscosity of the curable composition can begin to increase. The present invention can be advantageous in applications where fast dispensing and rapid bonding is required. For example, while the epoxy resin composition component and the hardener composition component are being mixed, a transition time, for the viscosity of the curable composition to increase to greater than 100 Pa·s to provide sufficient slump resistance, generally can be within a range of 10 seconds (s) to 900 s in one embodiment, within a range of from 30 s to 500 s in another embodiment, and within a range of from 50 s to 150 s in still another embodiment.

For example, in one embodiment, the curable epoxy adhesive composition during mixing under an applied shear of 10 l/s at 25° C. can have a viscosity within a range of from 100 Pa·s to 900 Pa·s. In another embodiment, the curable composition during mixing under an applied shear of 200 l/s at 25° C. can have a viscosity within a range of from 3 Pa·s to 15 Pa·s.

In still another embodiment, after the mixing of the components has stopped, i.e., once the applied shear is removed, the viscosity of the curable composition can continue to increase. For example, at 900 s after mixing has stopped, the curable composition can have a viscosity at 25° C. within a range of 100 Pa·s to 1000 Pa·s in one embodiment, within a range of 300 Pa·s to 900 Pa·s in another embodiment, and within a range of 400 Pa·s to 600 Pa·s in still another embodiment.

The curable epoxy resin adhesive composition of the present invention may be heat cured to form a cured product or thermoset. Generally, the curing of the curable adhesive composition may be carried out at a predetermined temperature and for a predetermined period of time sufficient to cure the curable adhesive composition. Curing the curable adhesive composition may be dependent on the epoxy resins and hardeners used in the curable adhesive composition.

The curing of the curable adhesive composition is generally carried out via thermal cure. For example, the temperature of curing the curable adhesive composition may be generally from 40° C. to 200° C. in one embodiment; from 50° C. to 100° C. in another embodiment; and from 70° C. to 90° C. in still another embodiment. Additional curing temperatures may be used for curing the curable adhesive composition of the present invention. For example, the curing temperature can include temperatures within a range of from 10° C. to 150° C. in one embodiment. The time period of a cure can range from minutes to several hours or days depending on the curing components, the final curable adhesive composition, and/or the particular application intended for the curable adhesive composition. For example in one embodiment, the curable adhesive composition can be cured in one step or in multiple steps. Additionally, in another embodiment, the curable adhesive composition can be post-cured using a different temperature or energy source after an initial cure.

The curing time may be chosen generally between 1 minute to 1 hour in one embodiment, between 5 minutes to 10 hours in another embodiment, and between 10 minutes to 7 hours in still another embodiment. Below a period of time of 1 minute, the time may be too short to ensure sufficient reaction under conventional processing conditions; and above 14 hours, the time may be too long to be practical or economical.

At substantially complete cure of the curable adhesive composition, generally more than 70 mol % of the thermosetting moieties of the curable adhesive composition have reacted in one embodiment, more than 80 mol % of the thermosetting moieties of the curable adhesive composition have reacted in another embodiment, and more than 90 mol % of the thermosetting moieties of the curable adhesive composition have reacted in still another embodiment.

The thermoset product (i.e. the cross-linked product made from the formulation) of the present invention shows several improved properties over conventional epoxy cured resins. For example, the cured product of the present invention (i.e., the C-staged material) may have a glass transition temperature (Tg) generally from 200° C. to 20° C. in one embodiment; from 150° C. to 30° C. in another embodiment; from 120° C. to 40° C. in yet another embodiment; from 100° C. to 40° C. in still another embodiment; and from 85° C. to 50° C. in one other embodiment. The Tg may be measured using a differential scanning calorimeter by scanning at 10° C./minute. The Tg is determined by the inflection point of the 2^{nd} order transition.

In still another embodiment, the cured product of the present invention (i.e., the C-staged material) may have residual stresses generally from 40 MPa to 1 MPa in one embodiment; from 20 MPa to 1 MPa in another embodiment; from 10 MPa to 1 MPa ° C. in yet another embodiment; from 8 MPa to 1 MPa in still another embodiment; and from 5 MPa to 1 MPa in one other embodiment. The residual stresses can be determined by beam deflection analysis of a bi-material beam using the geometry of the beam and the Modulus of Elasticity of the two materials in the bi-material beam.

The curable compositions of the present invention may be advantageously used as an adhesive, and in particular, as an adhesive used to bond relatively large structures that include, but are not limited to, aerodynamic wings, wind turbine blades, and automobile components. The curable compositions can be applied to a surface of one or between one or more structures and then cured. For example, the structures can be metal, plastic, fiberglass, or another material that the curable compositions can bond to. The curable composition can be applied manually, by a machine dispensing, spraying, rolling, or other procedures.

### EXAMPLES

The following examples further illustrate the present invention in detail but are not to be construed to limit the scope thereof.

The following materials were used in the Examples:

D.E.R.™ 331 (DER 331), an epoxy compound available from The Dow Chemical Company.

C₁₂-C₁₄ glycidylether, a diluent available from The Dow Chemical Company.

Versamid 140 (polyamidoamine), a curing agent available from Cognis Corporation.

Versamid 150 (polyamidoamine), a curing agent available from Cognis Corporation.

Genamid 491 (polyamidoamine), a curing agent available from Cognis Corporation.

Isophorone diamine (IPDA), a curing agent available from Evonik Industries.

Polyoxypropylene diamine, JEFFAMINE® D-400, a curing agent available from Huntsman International LLC.

HDK N 20 (fumed silica), a filler available from Wacker.

HDK H 18 (fumed silica), a filler available from Wacker.

Glass fiber (SiO₂, FG 400/060), a filler available from Schwarzwälder Textil-Werke, Germany.

The following viscosity measurements were carried out in the Examples:

Steady State Viscosity Measurement

Steady-state rheological measurements were conducted using an ARES Rheometer (TA Instruments, UK) in the shear rate range from 0.01 to 1000 s⁻¹ using a parallel plate geometry (25 mm diameter) at 25° C. Before each experiment, a steady pre-shear was applied at a 10 s⁻¹ shear rate for 60 seconds followed by a 300 second rest period. This procedure is necessary to erase any previous shear histories on the sample and to ensure that the sample establishes its equilibrium structure.

The following preparation procedures of the resin and hardener components were carried out in the Examples:

Preparation of Resin Component

A formulated epoxy resin component (A1) was prepared by blending ingredients as indicated in Table I. The epoxy resin component (A1) includes a blend of an epoxy compound, a diluent, a first filler and a third filler. Table I shows the weight percent of each of the various components in epoxy resin component (A1) based on the total weight of the resin component.

TABLE I

| | A1 |
|---|---|
| Component | (wt %) |
| Epoxy Compound: DER 331 | 72.5 |
| Diluent: C₁₂-C₁₄ Glycidylether | 7.3 |
| Filler: HDK N20 | 4.2 |
| Filler: Glass fiber | 16.0 |
| Total | 100 |

A low, middle, and high shear viscosity of epoxy resin component (A1) was measured at 25° C. The results of the viscosity measurements are shown in Table II.

TABLE II

| | Shear Rate | | |
|---|---|---|---|
| Viscosity | (1/s) | A1 | A2 |
| Low Shear Viscosity (Pa · s) | 5 | 80 | 23 |
| Middle Shear Viscosity (Pa · s) | 500 | 20 | 8 |
| High Shear Viscosity (Pa · s) | 1000 | 12 | 5 |

### Preparation of Hardener Components

Table III shows hardener component formulations (B1) and (B2). The hardener components (B1) and (B2) include a curing agent, a second filler, and a third filler. Table III shows the weight percent of each of the various components comprising the hardener components (B1) and (B2) based on the total weight of the hardener component.

TABLE III

| | B1 | B2 |
|---|---|---|
| Component | (wt %) | (wt %) |
| Curing Agent: Versamid 140 | 32.0 | — |
| Curing Agent: IPDA | 12.0 | 12.0 |
| Curing Agent: JEFFAMINE D-400 | 16.8 | 16.8 |
| Curing Agent: Versamid 150 | — | 51.2 |
| Curing Agent: Genamid 491 | 19.2 | — |
| Fumed silica: HDK H18 | 4.0 | 4.0 |
| Filler: SiO2 (Glass Fibers) | 16.0 | 16.0 |
| Total | 100 | 100 |

A low, middle, and high shear viscosity of hardener components (B1) and (B2) were measured at 25° C. The results of the viscosity measurements are shown in Table IV.

TABLE IV

| | Shear Rate | | |
|---|---|---|---|
| Viscosity | (1/s) | B1 | B2 |
| Low Shear Viscosity (Pa · s) | 5 | 8 | 8 |
| Middle Shear Viscosity (Pa · s) | 500 | 3 | 3 |
| High Shear Viscosity (Pa · s) | 1000 | 2 | 2 |

It can be seen from the results in Table II and Table IV that because of the type of thixotrope used as well as the level of the total filler content, the viscosity of the epoxy resin component (A1) and the viscosities of hardener components (B1) and (B2) are not increased above 30 Pa·s. As discussed above, it is advantageous to maintain the viscosity of the resin component and the hardener component below 30 Pa·s at 25° C. at an applied shear of 5 l/s to provide an epoxy adhesive composition capable of being used by gravity feed methods; to provide a non-sagging character of the mixed adhesive before gelation; and to provide a reasonably long room temperature (application temperature) open time (usually 45 minutes); and the resulting cured thermoset exhibits an improved toughness and resistance to stress cracking in the final adhesive bond.

### Examples 1 and 2

Curable compositions of the present invention (Examples 1 and 2) were prepared by combining a resin component and a hardener component to form a curable composition. Table V shows the curable composition for Examples 1 and 2, which comprise formulated adhesive compositions, based on a weight ratio of the resin component to the hardener component.

TABLE V

| | Curable Composition | | |
|---|---|---|---|
| Example | A1 | B1 | B2 |
| Example 1 | 100 | 40 | — |
| Example 2 | 100 | — | 46 |

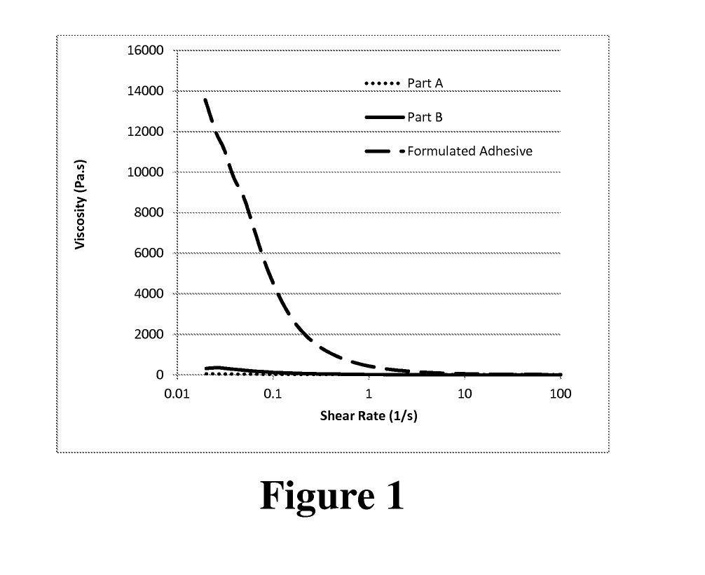

The rheology of adhesive composition of the present invention of Example 1 is shown in FIG. 1. A graphical illustration of the viscosity profile of the formulated adhesive of Example 1 as well as the individual components is shown in FIG. 1. The epoxy and hardener components in the composition of Example 1 have relatively low viscosities and display near Newtonian flow behavior. The adhesive mix, however, is highly viscous and sag resistant.

### Measurement of Residual Stresses

A custom-made draw down applicator was used to uniformly coat a stainless steel metal strip with an adhesive composition, taking care not to introduce any air bubbles. Three specimens were prepared for each composition. The samples were then placed in an oven to cure for 7 hours at 70° C. Fifteen minutes after removing from oven, the thickness of the sample (including the metal substrate) was measured at several spots on the strip to obtain an average thickness. The height of curvature was measured from outside radius to the chord midpoint. These measurements and tensile modulus values were used to calculate the residual stress in the adhesive of Example 1 and Example 2.

The residual stresses in the adhesive compositions of the present invention, Examples 1 and 2, are shown in Table VI.

TABLE VI

| | Example 1 | Example 2 |
|---|---|---|
| Residual Stress (MPa) | 4.2 | 3.5 |

1. A curable epoxy adhesive composition comprising:
(a) at least one first epoxy resin;
(b) at least one first diluent;
(c) at least one first hardener;
(d) at least a first hydrophilic filler that has a predetermined aspect ratio;
(e) at least a second hydrophobic filler that is different from the first filler, and that has a predetermined aspect ratio; and
(f) at least a third filler that is different from the first and second fillers; wherein the third filler has a predetermined aspect ratio higher than the first filler and the second filler; and wherein the volume ratio of the third filler to the combination of the first filler and second filler is in the range of from 1:1 to 10:1 such as to minimize the thermal residual stresses of the cured composition.

2. The curable composition of claim 1, wherein components (a)-(f) are separated into two components comprising (I) an epoxy resin composition component; and (II) a hardener composition component.

3. The curable composition of claim 2, wherein the epoxy resin composition (I) comprises (A) the at least one first epoxy, (B) the at least one first diluent, (C) the first hydrophilic filler, and (D) the third filler; and wherein the hardener composition (II) comprises (E) the second filler and (F) the third filler.

4. The curable composition of claim 2, wherein the epoxy resin composition (I) is from 35 weight percent to 60 weight percent, based on the total weight of the total composition; and; wherein the hardener composition (II) is from 15 weight percent to 30 weight percent, based on the total weight of the total composition.

5. The curable composition of claim 1, wherein the at least one first epoxy comprises diglycidyl ether of bisphenol A.

6. The curable composition of claim 1, wherein the at least one first diluent is a reactive diluent; and/or wherein the at least one first diluent comprises at least one second epoxy resin different from the at least one first epoxy resin.

7. The curable composition of claim 1, wherein the first hydrophilic filler and/or the second hydrophobic filler includes an additional filler that is hydrophilic, hydrophobic, or neither hydrophilic nor hydrophobic.

8. The curable composition of claim 1, wherein the first filler and the second filler is spherical in shape with a particle size in the range of from 1 nanometer to 50 microns.

9. The curable composition of claim 1, wherein the third filler has an aspect ratio greater than the first filler and greater than the second filler.

10. The curable composition of claim 1, wherein the third filler is rod shaped and wherein the length over diameter ratio (1/d) of the third filler is in the range of from 2 to 100.

11. The curable composition of claim 1, wherein the epoxy resin composition (I) and the hardener composition (II) each have a viscosity of no greater than 30 Pascal-second under an applied shear rate of 10 reciprocal seconds at 25 degrees Celsius; and wherein the curable composition, immediately after mixing the epoxy resin composition (I) and the hardener composition (II) together under an applied shear rate of 10 reciprocal seconds, has a viscosity of at least 100 Pascal-seconds at 25 degrees Celsius.

12. The curable composition of claim 1, wherein the curable composition during mixing at 25 degrees Celsius under an applied shear rate of 200 reciprocal seconds has a viscosity within a range of from 3 Pascal-second to 15 Pascal-second.

13. A cured product prepared by curing the curable composition of claim 1; wherein the cured product exhibits a balance of thermal and mechanical properties.

14. The cured product of claim 13 having a Tg of at least 65 degrees Celcius and a residual stress of below 5 megapascal.

15. A process for preparing a curable epoxy adhesive composition comprising admixing:
(a) at least one first epoxy resin;
(b) at least one first diluent;
(c) at least one first hardener;
(d) at least a first hydrophilic filler that has a predetermined aspect ratio;
(e) at least a second hydrophobic filler that is different from the first filler, and that has a predetermined aspect ratio; and
(f) at least a third filler that is different from the first and second fillers; wherein the third filler has a predetermined aspect ratio higher than the first filler and the second filer; and wherein the volume ratio of the third filler to the combination of the first filler and second filler is in the range of from 1:1 to 10:1 such as to minimize the thermal residual stresses of the cured composition.
